(19) United States
(12) Patent Application Publication
(10) Pub. No.: US 2016/0011429 A1
(43) Pub. Date: Jan. 14, 2016

(54) TRANSPARENT AUTOSTEREOSCOPIC DISPLAY

(71) Applicant: KONINKLIJKE PHILIPS N.V., Eindhoven (NL)

(72) Inventors: OLEXANDR VALENTYNOVYCH VDOVIN, MAARHEEZE (NL); BART KROON, EINDHOVEN (NL); EIBERT GERJAN VAN PUTTEN, 'S-HERTOGENBOSCH (NL); MARK THOMAS JOHNSON, ARENDONK (BE)

(21) Appl. No.: 14/772,543

(22) PCT Filed: Mar. 7, 2014
(86) PCT No.: PCT/IB2014/059530

§ 371 Date: Sep. 3, 2015

Related U.S. Application Data
(60) Provisional application No. 61/776,968, filed on Mar. 12, 2013.

(51) Int. Cl. G02B 27/22; G02B 26/00; G02F 1/1335; H04N 13/04

(52) U.S. Cl. CPC G02B 27/2214; H04N 13/0452; H04N 13/0456; H04N 13/0404; H04N 13/0409; H04N 13/0445; G02B 26/005; G02F 1/133526

(57) ABSTRACT

The invention provides an autostereoscopic display which combines a display panel with a transparent mode and switchable optical arrangement for directing different views in different spatial directions to enable autostereoscopic viewing, and which also has a transparent mode. The display has (at least) at least a 3D autostereoscopic display mode in which the display is driven and the optical arrangement is used for generating views, and a transparent display mode in which the display and optical arrangement are driven to transparent modes to provide an undistorted view of the image behind the display.

### FIELD OF THE INVENTION

This invention relates to transparent displays, and in particular to transparent autostereoscopic displays.

### BACKGROUND OF THE INVENTION

Transparent displays enable a background behind the display to be viewed as well as the display output. The display thus has a certain level of transmittance. Transparent displays have many possible applications such as windows for buildings or automobiles and show windows for shopping malls. In addition to these large device applications, small devices such as hand held tablets may also benefit from transparent displays, for example to enable a user to view a map as well the scenery ahead though the screen.

It is expected that much of the existing display market will be replaced by transparent displays, for example in the fields of construction, advertisement and public information. Transparent displays are not yet available with 3D viewing capability, and in particular not yet using glasses-free autostereoscopic approaches, such as with lenticular lenses.

A transparent display typically has a display mode when the viewer is intended to view the display content, and a window mode when display is off and the viewer is intended to be able to see through the display. A conventional combination of a lenticular lens on top of a display, as is common in autostereoscopic 3D displays, causes a problem if the display is transparent as the lenticular lens will cause a distorted view of the image behind the display. Thus, the window mode does not provide a proper view of the scene behind the window.

### SUMMARY OF THE INVENTION

The invention is defined by the claims. According to one aspect of the invention, there is provided an autostereoscopic display comprising:

a display panel having a display mode and a transparent mode in which the panel is substantially transparent; and

a switchable optical arrangement for directing different views in different spatial directions to enable autostereoscopic viewing, wherein the optical arrangement is switchable between a multi-view mode and a transparent non-lensing mode,

wherein the display has at least a 3D autostereoscopic display mode in which the display panel is driven to the display mode and the optical arrangement is driven to the multi-view mode, and a transparent display mode in which the display is driven to the transparent mode and the optical arrangement is driven to the transparent mode.

The invention provides a display which is capable of displaying 2D content in a 2D mode, 3D content in autostereoscopic mode and also having a transparent mode. By substantially transparent is meant that it is possible to look through the panel and view the scene behind. In practice, an average 50% transparency across for the visible spectrum is sufficient for this purpose, although the transparency can be higher such as 60%, 70% or 80%. The switching of the optical arrangement enables switching between the 3D mode and the 2D or transparent modes, since both require the absence of a lensing function.

The autostereoscopic mode is one in which at least two different images are displayed in different directions, so that one image reaches one eye of the viewer and a different image reaches the other eye. There can be only one stereoscopic image (i.e. two different images) or there can be many stereoscopic images, such as 3, 7 or 10. In the case of lenticular lenses, each lens will overlie a set of pixels in the row direction so that different pixels are associated with different light path directions. The number of views may correspond to the number of pixels beneath each lens, or the multiple views may be shared by different lenses (if the lens pitch is not an integer multiple of the pixel pitch). These issues are all well known to those skilled in the field of autostereoscopic displays.

The optical arrangement function is preferably independent of the polarization of light, so that the overall transmittance of the display can be kept high. This arrangement can either have no influence on light rays propagating through it, or act as the view directing arrangement, which can be a parallax barrier, a lenticular lens or microlens array.

The display panel has pixels that are in at least one state sufficiently transparent for a see through mode. This transparency can be because the pixel layers are transparent when turned off or because the pixel aperture is small. A small pixel aperture is for example opaque pixels which occupy less than 50% of the display area, or even less than 30%.

In the case of a small pixel aperture, reflective pixels, non-transparent OLED pixels or backlit pixels can be used and the aperture ratio allows for overall significant transmittance through the display. The pixels can be provided with a rear reflector.

The display panel can comprise:

a transparent organic light emitting diode display panel;

an electrowetting pixel display panel;

an electrofluidic pixel display panel;

an in plane-electrophoretic pixel display; or

a roll-out MEMS pixels display.

The switchable optical arrangement can comprise:

electrowetting microlens cells;

electrowetting lenticulars cells;

an optical adjuster beam shaper comprising a pair of birefringent lenticular lens arrays with a switchable LC material between the lenticular lens arrays;

a switchable parallax barrier; or

a birefringent lens plus a switchable polarizer or a polarizer and a switchable retarder.

These different display and optical arrangements can be combined in different ways.

A switchable optical diffuser or absorber can be provided on the opposite side of the display panel to the switchable optical arrangement. For a display design using transmissive pixels, a diffuser can be used to mix the light transmitted through the display to the back side of the display. The diffuser will also provide more uniform illumination of the back of the display panel. In the transparent mode, the diffuser can be turned off

For a display design using emissive pixels, an absorber can be used to block light. In 3D mode, the image does not want to be sent in the back direction because there is no optical arrangement to form the views. In 2D mode, the image typically does not want to be sent in the back direction because it will appear inverted. The absorber can prevent these views, and it can also increase the contrast ratio of the displayed image. The absorber can also be switchable.

The display panel can comprise transparent OLED pixels, and the switchable optical arrangement can comprise electrowetting lenses. This arrangement has the advantage of the possibility of high switching speed.

A controller can be provided for controlling the switching of the switchable optical arrangement and the pixels in synchronism, and to control a duty cycle of the switching to vary the ratio of display transparency to displayed image brightness. This drive scheme preferably uses a fast response optical arrangement such as the electrowetting lenses. The duty cycle can then be adjusted such that the scenery behind the display can be seen undistorted, but still with considerable display brightness.

The switchable optical arrangement can comprise microfluidic lens segments forming an array of Fresnel lenses, with each Fresnel lens formed from a set of lens segments. This enables control of the lens shapes. For example, a controller can be provided for controlling the switching of the microfluidic lens segments, thereby to vary the pitch of the Fresnel lenses by varying the number of lens segments forming each Fresnel lens.

As mentioned above, the display can be controlled in different modes.

For example, the display can be controllable to be driven to:

a transparent mode;

an autostereoscopic display mode; or

a 2D display mode with the switchable optical arrangement turned off and the display panel turned on.

These modes can apply to all different implementations of the device.

The display can further be controllable to be driven to:

a first hybrid mode comprising one or more regions of 2D display content and

a transparent region; or

a second hybrid mode comprising one or more regions of 3D display content and a transparent region.

There may also be a third hybrid mode comprising one or more regions of 2D display content, one or more regions of 3D display content and a transparent region.

### BRIEF DESCRIPTION OF THE DRAWINGS

An example will now be described in detail with reference to the accompanying drawings, in which:

FIG. 1 shows a known electrowetting lens design;

FIG. 2 shows a known polarization independent switchable beam steering arrangement;

FIG. 3 shows a first example of a display of the invention;

FIG. 4 shows different modes in which the display can be driven;

FIG. 5 shows a possible transparency/brightness control method;

FIG. 6 shows a second example of a display of the invention;

FIG. 7 shows a third example of a display of the invention;

FIG. 8 shows a fourth example of a display of the invention;

FIG. 9 shows a fifth example of a display of the invention; and

FIG. 10 shows the display with associated control system.

### DETAILED DESCRIPTION OF THE EMBODIMENTS

The invention provides an autostereoscopic display which combines a display panel with a transparent mode and switchable optical arrangement for directing different views in different spatial directions to enable autostereoscopic viewing, and which also has a transparent mode. The display has at least a 3D autostereoscopic display mode in which the display is driven and the optical arrangement is used for generating views, and a transparent display mode in which the display and optical arrangement are driven to transparent modes.

Before describing various examples, some of the options and issues for the design of a transparent 3D display with an undistorted and polarization independent transparent mode are discussed below.

One way to provide an undistorted transparent mode is to use a switchable lens system.

One type of switchable lens system uses the polarization of the light emitted by the display to control a viewing mode (i.e. transparent or 3D). Polarization switching can then be used to alternate between modes. Light is either polarised by the light source or polarising elements are integrated into the lens or into the optical switching arrangement. This intrinsically limits the total transmittance of a display (at least by 50%) while a high transmittance is one of the key parameters for the look-through displays. It is preferable therefore to implement the switching function in a polarization-independent way, and this is particularly important for transparent displays.

A first possibility to realise a polarisation independent switchable lens is using the electrowetting principle.

A possible implementation of an electrowetting lens is described in U.S. Pat. No. 7,307,672. An advantage of an electrowetting cell for switchable lenses is that they have a fast response time (especially for smaller cell sizes, typical for micro-arrays) and can be driven at frequencies in the kHz range.

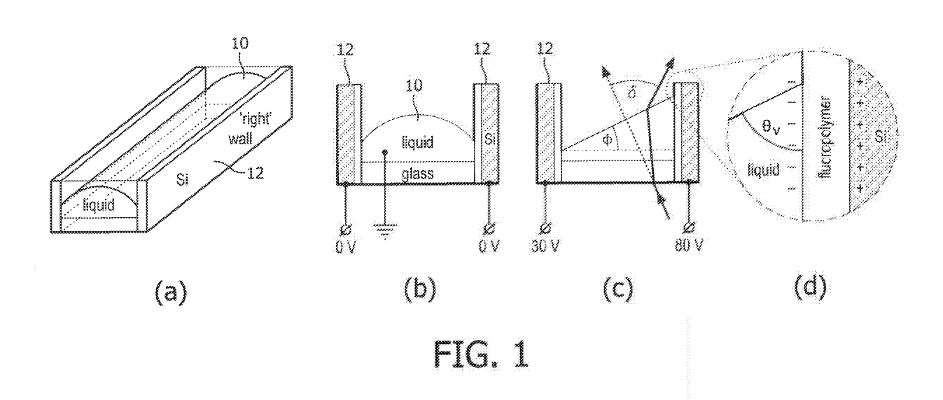

FIG. 1 shows in simplified form the structure of such a lens (reproduced from Smith N. R. et al, Optics express 14 (2006) 6557). FIG. 1(a) shows the structure in perspective view. The lens comprises a chamber containing a liquid 10. The side walls of the chamber are provided with an electrode arrangement comprising opposing sidewall electrodes 12. When the voltages applied on both sidewall electrodes of a cell of this type of structure are the same, the liquid interface will have some curvature resulting in a lens action as shown in FIG. 1(b). For a rectangular cell with different voltages on sidewall electrodes, these voltages can be adjusted in order to have a flat meniscus with a controllable slope with respect to the bottom plane of the cell as shown in FIG. 1(c), thereby resulting in a micro-prism element (known as electrowetting micro prisms, EMP). The contact angle defines the slope of the surface as shown in FIG. 1(d). These micro prisms are then used for deflection of a light beam.

The dimensions of an electrowetting cell can be equal to or smaller than 100 micrometers. In principle this allows the formation of Fresnel-type lenses, with each lens composed out of multiple segments, each individual segment being realised with an EMP cell providing different tilt angle.

A second possibility to realise a polarisation-independent switchable lens is to use a combination of two lenticulars lenses, the material of which has the orientation of their optical axis mutually perpendicular to each other, and a layer of switchable birefringent material in between.

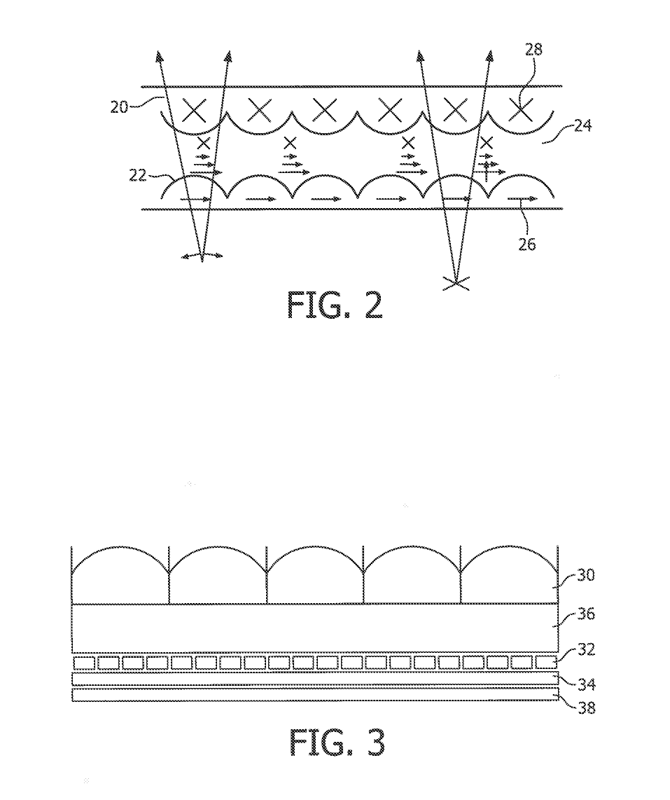

This arrangement is shown in FIG. 2, which shows first and second lenticular arrays 20,22 with twisted nematic LC (TNLC) material 24 between. The optical axes of the lenses are shown as 26 and 28. This structure is described in detail in WO 2011/051840.

The switchable optical element when in the off state is transparent and does not change the propagation direction of light. In the on-state, the alignment of the optical axis of the switchable twisted nematic liquid crystal (TNLC) material between the lenses changes and aligns perpendicular to the optical axis of both the first and second lenticulars arrays 20,22 and the structure will have a lens function independent of polarisation of incident light.

In addition to a switchable lens function to enable a clear transparent mode, the display itself must have inherent transparency.

For a transparent display, pixel technologies are needed that enable the display panel to be switched to a transparent state. Examples of technologies that can be used for display pixels capable of being switched to sufficiently transparent state are:

transparent OLEDs, emitting unpolarised light;

pixels based on electrowetting cells. The display can work in a transmissive mode (with no back reflector) or reflecting mode (with a back reflector);

electrofluidic cells (with transparent or transmissive/reflective pixels);

in plane-electrophoretic cells (with transparent or reflective pixels);

roll-out MEMS type pixels (with transparent or reflective pixels).

The pixels should have high transparency, be polarisation independent and have fast response time.

The invention combines the different technologies to provide a polarization independent transparent mode in addition to at least a 3D autostereoscopic mode.

FIG. 3 shows a first example of display device of the invention, which is switchable between 2D and 3D modes, and uses a transparent display panel.

The device comprises a polarisation-independent switchable optical element 30 for providing the autostereoscopic multi-view display function. In the on state the element acts as parallax barrier, lenticular lens or microlens array, providing the user with multiple stereoscopic views. In the off state the element has no optical function for light rays passing through it.

Such an element can be realised with electrowetting microlens cells, electrowetting lenticulars cells or with an optical adjuster as shown in FIG. 2. A parallax barrier, although not a preferred option as it will result in lower transmittance, can be realised with electrowetting optical switches comprising black ink.

The display panel has transmissive pixels 32 on a substrate 34. The pixels are realised with one of the known technologies for transparent pixels, namely OLED, electrowetting, electrofluidic or electrophoretic or MEMS pixel technology. The pixels could be integrated into the structure of the substrate, for example in the case of a silicone substrate.

An optional spacer 36 is formed from an optically transparent material to match a focal plane of an optical element in the on state with the pixel plane. The required spacing may instead be provided by the optical element 30.

To realise a look-through mode, the optical element 30 is driven into the off state. In this way, the interface between the optical element material and the air is flat (for the example of electrowetting technology) and it does not distort the propagation direction of light rays passing through. The pixels are also switched to their off, transparent state. The whole display has an appearance of a transparent material.

In the 3D mode the optical element will refract light propagating from pixels and redirect it in multiple directions, where it can be observed by user as different views. A 2D mode can be realised either by rendering, such that all pixels contributing to one viewing cone will have same intensities (both eyes of user will see the same views), or switching the optical element into off state and displaying 2D content on the display.

This display configuration has the advantage that the switchable optical element will transmit the light independent on its polarisation, therefore the overall transmittance of the display is high.

The device can be realised with either transmissive pixels (electrowetting shutters, in-plane electrophoretic etc.) or emissive pixels (for example transparent OLEDs).

In the case of transmissive pixels, the light source for the pixel display is in the form of the light reaching the display from the other side, namely from bottom to top in FIG. 3. An additional electro-optically switchable diffuser 38 can be added to the back side of the pixels, with the function of blurring the image for the observer situated on the back side of the display and to make the illumination for the transmissive pixels more uniform. The diffuser 38 can be switched between diffusing and transparent states, and can be realised for instance with a PDLC material. This type of optical shutter element can have either transparent or translucent white appearance when acting as a diffuser. These elements are known in use for privacy protection glass and sometimes for display applications.

In the case of emissive pixels, a switchable absorber layer 38 can be added on the back side of the pixels, to increase a contrast ratio for displayed images. A switchable absorber can be realised, for instance, with electrophoretic ink. The layer 38 is thus either a diffuser or an absorber depending on the type of pixels used.

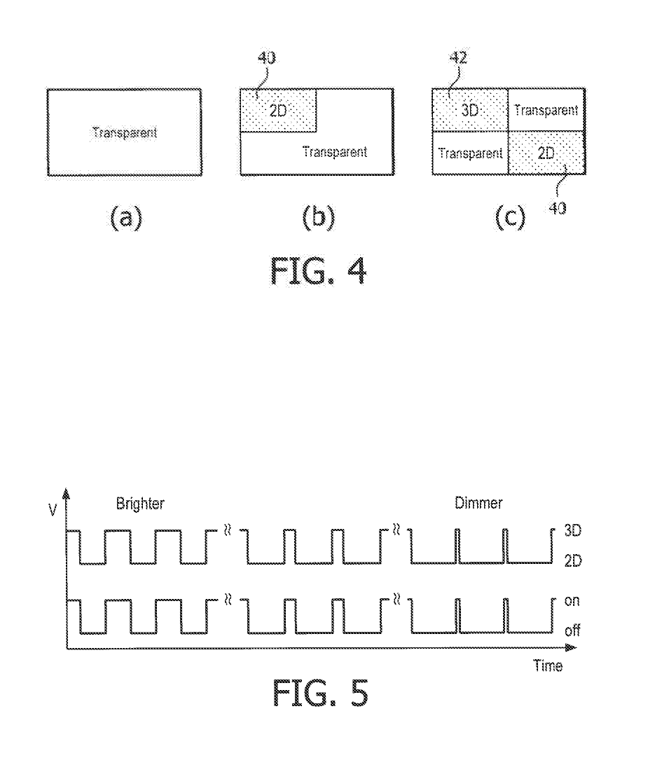

The display can be controlled to provide a completely transparent mode in which the background scene is seen through the display as shown in FIG. 4(a).

FIG. 4(b) shows a partially transparent display with 2D content 40. This 2D content can be displayed on the full screen or locally over a sub-area of the display as shown in FIG. 4(b), or in multiple regions. FIG. 4(c) shows a partially transparent display mode with 3D content 42 as well as 2D content 40 over different display areas. Of course there can be 2D or 3D content over the full screen or any combination of display areas.

A first more specific example will now be described, based on the use of transparent OLEDs as the pixels 32 in FIG. 3 and an electrowetting lens structure as the lenses 30 in FIG. 3.

The transparent OLED emitters and the electrowetting optical element can have fast switching response, for example up to the kHz range, and this example makes of use this switching capability. For display applications, switching at or above the 100 Hz range is of particular interest. The lens structure and OLEDs can be switched synchronously and simultaneously between the on and off states. By varying time ratio between the on and off states (i.e. the duty cycle) both for the optical elements of the display and the pixels in a continuous way, variation in the degree of transparency of the display can be realised.

This control approach is shown in FIG. 5, which is a schematic timing diagram to show the synchronised timing. FIG. 5 does not reflect actual driving conditions of a single lens element or a single pixel, but rather represents only the synchronised time intervals.

During a brighter period, the pixels are on and the lens system is driven to the 3D mode for a larger duty cycle. During a dimmer period, the pixels are on and the lens system is driven to the 3D mode for a lower duty cycle. This means the display is driven to the transparent mode for a longer fraction of the time, and the transparency is accordingly increased. The limiting (smallest) pulse width in FIG. 5 will typically be determined by the switching rate of the display pixels, and may be of order of single milliseconds.

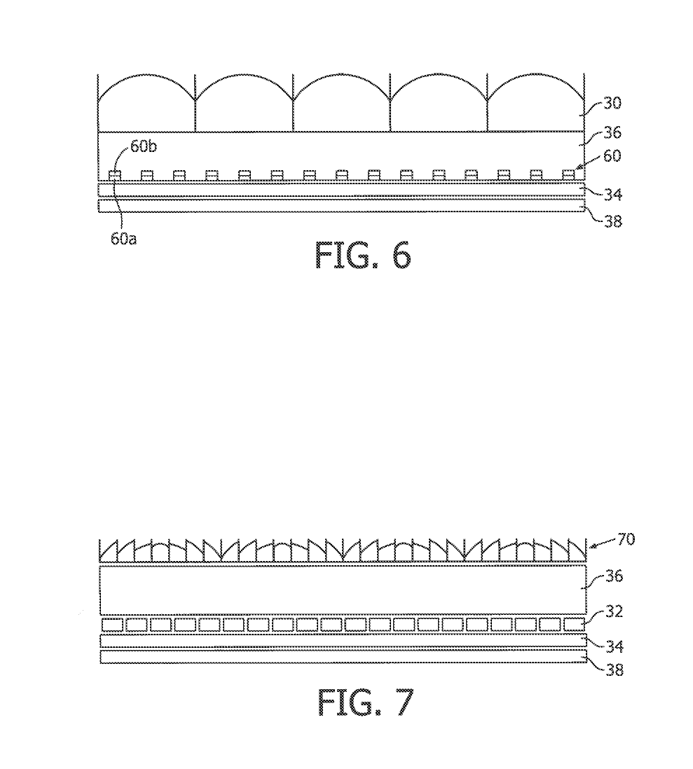

A second example is shown in FIG. 6. This example uses non-transparent pixels 60, for example reflective pixels, non-transparent OLED, or backlit pixels. FIG. 6 shows a pixel structure comprising a reflector 60a beneath the pixel light modulator layer 60b. The other components are as in FIG. 3, namely the switchable optical elements 30, optional spacer 36, substrate 34 and optional switchable diffuser or absorber 38.

The aperture ratio of each pixel is small, such that around each pixel there is a significant area of substrate which is transparent. In this way, the total transparency of the panel is sufficiently high. Therefore, when the lens is in the off state the observer will see a real background scene almost undisturbed.

Since the pixels are not transparent, the reflector 60a at the back side of the pixel is used to mask the pixel from the observer situated on the back side of the display and to increase the display contrast.

FIG. 7 shows a third example which makes use of a Fresnel lens with pitch adjustment for different viewing distances.

This example enables adjustment of the 3D display to changing distance between the display and a user (viewing distance), by electro-optical adjustment of the pitch of a lens array.

The device comprises the substrate 34, spacer 36 and optional diffuser or absorber 38 as in the examples above. The device has transparent pixels 32 and the lens arrangement is implemented as Fresnel lenticulars 70.

For optimal perception of 3D images at very different distances from the display, it is advantageous to adjust the pitch of the lenses. A lenticular lens with tuneable pitch can be realised with a Fresnel-type lenticular lens. Each lens is formed from multiple segments as shown, and the segments each comprise electrowetting micro prism cells. By addressing each segment independently it is possible to adjust a tilt angle of each prism such as to adjust the pitch of the lens formed by multiple segments. In the example of FIG. 7, seven such segments form a single lens.

This approach can be used also in combination with non-transparent pixels with small aperture ratio, as explained with reference to FIG. 6.

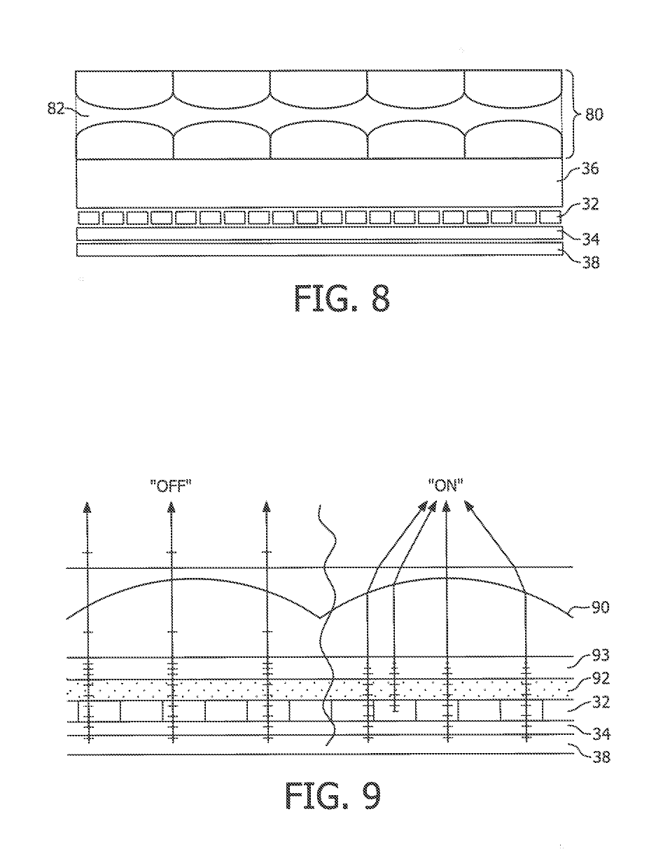

A fourth example is shown in FIG. 8. Again, the basic structure is as in FIG. 3, with the substrate 34, spacer 36 and optional diffuser or absorber 38 as in the examples above. This example again makes use of transparent pixels 32.

The switchable polarisation-independent lens 80 is realised using the structure shown in FIG. 2. Thus, the switchable optical element comprises a thin stack of two lenticulars lenses made from birefringent material, whose optical axes are oriented perpendicular to each other. A layer of switchable birefringent material 82 (for instance twisted nematic liquid crystal material) in provided between the lenses.

The switchable layer is configured such that at each interface with a lens, the orientation of the optical axis of the switchable material is parallel to the optical axis of the respective lens material.

In the off state there is no change of refractive index at the interfaces of the lenses with the switchable material and consequently the optical element will have no lens action.

When the optical element is in the on state, the optical axis of the switchable birefringent material aligns perpendicular to both optical axes of the material of the lenticular lenses. In this state, light propagating through optical element will go through the interfaces with a difference in refractive index, and will refract on the lenses.

This type of switchable optical element will function for polarised and unpolarised light.

A fifth example is shown in FIG. 9. Again, the basic structure is as in FIG. 3, although the optional spacer is omitted from FIG. 9. This example again makes use of transparent pixels 32.

The lens 90 is realised from non-switchable birefringent material, such as a UV-cured polymerised LC solution, such that incoming light with one polarisation is refracted, and the other is not.

The switchable layer consists of a polariser 92 and a switchable retarder 93 with an on and off state. The retarder rotates the polarization plane of incoming light by 90 degrees in one of the two states. Alternatively, the elements 92 and 93 can be integrated into one component; a switchable polarization rotator.

In the off state there is no change of refractive index at the interfaces of the lenses with the switchable material and consequently the optical element will have no lens action.

When the switchable retarder is in the on state, the polarisation direction of the transmitted light is such that light propagating through the optical element will go through the interfaces with a difference in refractive index, and will refract on the lenses. The advantage of this fifth example of switchable optical element over the fourth example is a much thinner layer of the active material, which allows for much faster switching between the on and off states. Thus, this technology can also be used for implementing the duty cycle control explained with reference to FIG. 5.1

The invention can be applied in transparent display devices, ranging from hand-held devices to smart windows. The 2D/3D and transparent switchable features in combination with local addressing are of particular interest for entertainment and advertisement functions.

Within practical limits, there could be any number of 2D, 3D and transparent regions. The lens arrangement could for example have N by M independently switchable sections (square or rectangular) where each section would cover one or more individual lenses. Because the lens has to be switched quickly, active matrix technology could be employed.

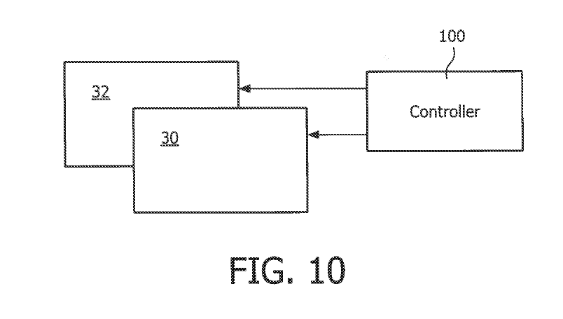

It will be clear from the above that both the display panel 32 and the optical arrangement 30, 70, 80, 92/93 need to be controlled to switch between the possible display modes. As shown in FIG. 10, a controller 100 is provided for this purpose. The viewing mode can be selected automatically based on an analysis of the data being displayed, i.e. with embedded information to indicate which areas are to be transparent, 2D or 3D. Alternatively, there can be external input to set the display mode. The controller 90 thus combines the display driver as well as the optical controller.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A transparent autostereoscopic display comprising:
a display panel having a display mode and a transparent mode in which the display panel is substantially transparent and the display has a window mode; and
a polarization independent optical arrangement for directing different views in different spatial directions to enable autostereoscopic viewing,
wherein the optical arrangement is switchable between a multi-view mode and a transparent non-lensing mode in which light is transmitted independent of its polarisation, and
wherein the display has at least a 3D autostereoscopic display mode in which the 1 display panel is driven to the display mode and the optical arrangement is driven to the multi-view mode, and a transparent display mode in which the display is driven to the transparent mode and the optical arrangement is driven to the transparent non-lensing mode.

2. A display as claimed in claim 1, wherein the display panel is a display panel chosen from the group consisting of transparent organic light-emitting diode display panels, electrowetting pixel display panels, electrofluidic pixel display panels, in-plane-electrophoretic pixel display panels, and roll-out MEMS pixels display panels.

3. A display as claimed in claim 1, wherein the switchable optical arrangement comprises:
electrowetting microlens cells;
electrowetting lenticulars cells; or
an optical adjuster beam shaper comprising a pair of birefringent lenticular lens arrays with a switchable LC material between the lenticular lens arrays.

4. A display as claimed in claim 1, further comprising a switchable optical diffuser or switchable absorber on the opposite side of the display panel to the switchable optical arrangement.

5. A display as claimed in claim 1, wherein the display panel comprises pixels which are transparent when turned off.

6. A display as claimed in claim 1, wherein the display panel comprises transparent OLED pixels, and the switchable optical arrangement comprises electrowetting lenses.

7. A display as claimed in claim 1, wherein the display panel comprises opaque pixels which occupy less than 50% of the display area.

8. A display as claimed in claim 7, wherein the pixels comprise a rear reflector (60a).

9. A display as claimed in claim 1, comprising a controller for controlling the switching of the switchable optical arrangement and the pixels in synchronism, and to control a duty cycle of the switching to vary the ratio of display transparency to displayed image brightness.

10. A display as claimed in claim 1, wherein the switchable optical arrangement comprises electrowetting lens segments forming an array of Fresnel lenses, with each Fresnel lens formed from a set of lens segments.

11. A display as claimed in claim 10, comprising a controller for controlling the switching of the microfluidic lens segments between the multi-view mode and the non-lensing mode and to vary the pitch of the Fresnel lenses when in the multi-view mode by varying the number of lens segments forming each Fresnel lens.

12. A display as claimed in claim 1, wherein the display is controllable to be driven to:
a transparent mode;
an autostereoscopic display mode; or
a 2D display mode with the switchable optical arrangement turned off and the display panel turned on.

13. A display as claimed in claim 12, wherein the display is further controllable to be driven to:
a first hybrid mode comprising at least one region of 2D display content and a transparent region; or
a second hybrid mode comprising at least one region of 3D display content and a transparent region; or
a third hybrid mode comprising at least one region of 2D display content and at least one region of 3D display content.

14. A display as claimed in claim 13, wherein the display is further controllable to be driven to:
a fourth hybrid mode comprising at least one region of 2D display content, at least one region of 3D display content and a transparent region.

15. A hand held device, shop window or advertisement window comprising a display as claimed in claim 1.
